(19) United States
(12) Patent Application Publication
(10) Pub. No.: US 2008/0266706 A1
(43) Pub. Date: Oct. 30, 2008

(54) MAGNETIC HEAD AND DISK APPARATUS

(75) Inventor: Michinaga Yamagishi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/147,206

(22) Filed: Jun. 26, 2008

Related U.S. Application Data
(63) Continuation of application No. PCT/JP2005/023954, filed on Dec. 27, 2005.

(51) Int. Cl. G11B 5/596

(52) U.S. Cl. 360/77.06

(57) ABSTRACT

A magnetic head having a recording head portion for recording information at an arbitrary position on a magnetic recording surface of a recording medium and also having a reproducing head portion containing a reproducing head element for reproducing the information recorded at the arbitrary position on the magnetic recording surface forms a reproducing head element, the shape of which is curved, being made after a curved shape of a magnetization pattern recorded at the arbitrary position of the recording medium. Due to the foregoing, a shape of the lead gap formed between the reproducing head element and the magnetic recording surface of the recording medium is made to substantially agree with the shape of the magnetization pattern. On the other hand, a disk apparatus having a reproducing head element is provided in which the shape of the lead gap is made to substantially agree with the shape of the magnetization pattern.

### CROSS REFERENCE TO RELATED APPLICATION

This is a Continuation of Application No. PCT/JP05/023954 filed on Dec. 27, 2005. The entire disclosure of the prior application is hereby incorporated by reference herein in its entirety.

### BACKGROUND OF THE INVENTION

1. Field of the Invention

The present invention relates to a magnetic head having a recording head portion for recording information (data) at an arbitrary position on a magnetic recording surface of a recording medium by using a magnetic recording system and also having a reproducing head portion for reproducing the information (data) recorded at the arbitrary position of the magnetic recording surface of the recording medium. The present invention also relates to a disk apparatus such as a magnetic disk apparatus or an optical disk apparatus having the magnetic head concerned.

2. Description of the Related Art

In a disk apparatus such as a magnetic disk apparatus or an optical magnetic disk apparatus, an operation of writing data is carried out by recording information at an arbitrary position (for example, in an arbitrary track) on a magnetic recording surface of a recording medium such as a disk by using a magnetic head represented by a thin film magnetic head and an operation of reading data is carried out by reproducing information recorded at an arbitrary position on the magnetic recording surface concerned.

With regard to the magnetic recording system of recording data in the recording medium such as a disk, a longitudinal magnetic recording system, which has already been put into practical use, is provided in which a direction of the magnetizing signal is an in-plane direction of the recording medium and a perpendicular magnetic recording system is also provided in which a direction of the magnetizing signal is a direction perpendicular to a magnetic recording surface of the recording medium. Generally, it is said that a perpendicular magnetic recording system is not likely to be affected by a thermal fluctuation of the recording medium compared with the longitudinal magnetic recording system. It is said that it is possible for the perpendicular magnetic recording system to realize a relatively high magnetic recording density (for example, a relatively high linear recording density).

Generally, in a disk apparatus in which the longitudinal magnetic recording system is used, in order to stably carry out a writing operation of writing data and a reading operation of reading data for an arbitrary track on a magnetic recording surface of a disk, a predetermined gap is provided between a recording head portion and a magnetic recording surface and between a reproducing head portion and a magnetic recording surface.

A shape of the gap (lead gap) provided between the reproducing head portion and the magnetic recording surface is usually rectangular. In this case, in order to increase density of the disk apparatus, a core width of the magnetic head is reduced so that a track density can be increased or alternatively, information is recorded being crammed in the bit direction. However, in order to enhance the magnetic recording density, the core width of the magnetic head has already been reduced. Therefore, it is considerably difficult to realize a process in which a prescribed core width is built. Therefore, the yield of manufacturing the magnetic head is decreased and the manufacturing cost is raised. Further, there is a tendency in which a ratio of signal to noise (SN ratio) of the reproduction signal are produced by the reproducing head portion is lowered. Accordingly, it is difficult to increase density of the disk apparatus in which the longitudinal magnetic recording system is used.

On the other hand, in the perpendicular magnetic recording system which is an effective technique to cope with a tendency of increasing the density of the disk apparatus, a shape of a head flying surface of a reproducing head element provided in the reproducing head portion is formed to be rectangular. In this perpendicular magnetic recording system, a shape of the gap formed between the reproducing head portion and the magnetic recording surface is determined by a shape of the reproducing head element provided in the reproducing head portion. Therefore, in the same way as that of the longitudinal magnetic recording system, the shape of the gap is rectangular.

In the case in which information is recorded on the magnetic recording surface of the magnetic recording medium by the perpendicular magnetic recording system by using a single magnetic pole type perpendicular magnetic recording head which is usually a recording head portion of the magnetic recording head, contour lines of the recording magnetic field intensity in a portion close to the magnetic recording surface are distributed being formed as concentric circles, wherein the maximum intensity is a central portion of the single primary magnetic pole portion in the recording head portion. This distribution is swelled when it comes to the outside of the contour lines. Therefore, a shape of the distribution of the recording magnetic filed intensity to determine a magnetization state of the magnetic recording surface on the recording medium is curved.

In the case in which information is recorded on the recording medium such as a disk by using the recording head portion having the above recording magnetic field intensity distribution, a shape of the magnetization pattern recorded in an arbitrary track on the magnetic recording surface of the recording medium is curved with respect to a longitudinal direction (bit direction) of the track.

In the case in which information is reproduced by the reproducing head portion, the shape of the lead gap of which is rectangular, with respect to the magnetization pattern, the shape of which is curved as described above, a portion of the bit in the front is reproduced by an end portion of the track. Therefore, in the case of the magnetic head of the conventional perpendicular magnetic recording system, edge noise generated by an edge portion of the track is mixed in a reproduction signal and a ratio of signal to noise (SN ratio) of the reproduction signal is lowered. At the same time, according to an increase in the linear recording density of the recording medium, a track width in which the curved magnetization pattern is recorded is substantially reduced. Due to this problem, it is more difficult to realize a disk apparatus of higher density.

In order to solve the above problems, Patent Document 1 described below discloses one measure which will be explained as follows. Attention is paid to a phenomenon in which a shape of the head flying surface of the primary magnetic pole portion of the perpendicular magnetic recording head affects a distribution of the recording magnetic field intensity. Therefore, with respect to the primary magnetic pole portion of the perpendicular magnetic recording head, a recess portion is formed on the downstream side in the rotational direction of the recording medium, i.e., on the trailing side. The above magnetic head is described in Patent Document 1.

However, generally, in order to attain a high density of the disk apparatus, a primary magnetic pole portion of the perpendicular magnetic recording head is formed out of a fine structure in which a relatively high dimensional accuracy is required. From the technical viewpoint, it is difficult to form a recess portion in the primary magnetic pole portion having such a fine structure. Accordingly, it is impossible in practical to manufacture a perpendicular magnetic recording head described in Patent Document 1. A shape of the magnetization pattern recorded on the magnetic recording surface of the recording medium is still curved with respect to the longitudinal direction of the track. Further, in the case of Patent Document 1, no countermeasures are taken for the shape of the reproducing element of the reproducing head. Therefore, the same problems as those caused in the case of using the magnetic head of the conventional perpendicular magnetic recording system are still caused in the technique described in Patent Document 1 described below. Patent Document 1: Japanese Unexamined Patent Publication (Kokai) No. 2002-279606

In this connection, the magnetic head of the conventional perpendicular magnetic recording system and the problems caused in the system will be described in detail later with reference to the accompanying drawings.

### SUMMARY OF THE INVENTION

An object of the present invention is to provide a magnetic head and a disk apparatus in which SN ratio of a reproduction signal can be enhanced without being affected by a magnetization pattern, the shape of which is curved, which is recorded on a magnetic recording surface of a recording medium especially in the case of reproducing information by using the perpendicular magnetic recording system, so that a higher density of the magnetic disk apparatus can be attained.

In order to attain the above object, the first aspect of the present invention provides a magnetic head comprising a recording head portion for recording information at an arbitrary position on a magnetic recording surface of a recording medium; and a reproducing head portion including a reproducing head element for reproducing information recorded at the arbitrary position on the magnetic recording surface, wherein when the reproducing head element is formed being made after a shape of a magnetization pattern recorded at the arbitrary position of the recording medium, a shape of a gap formed between the reproducing head element and the magnetic recording surface is made to be substantially the same as the shape of the magnetization pattern.

The second aspect of the present invention provides a magnetic head comprising the same recording head portion and reproducing head portion as those of the first aspect of the present invention, in which a window portion is formed in one portion of the magnetic shielding member being made after the shape of the magnetization pattern recorded at the arbitrary position of the recording medium, and when a reproducing head element, the size of which is not less than the size of the window portion of the magnetic shielding member, and the magnetic shielding member are combined with each other, a shape of the gap formed between the reproducing head element and the magnetic recording surface is made to be substantially the same as the shape of the magnetization pattern.

The third aspect of the present invention provides a magnetic head comprising the same recording head portion and reproducing head portion as those of the first aspect of the present invention, in which the reproducing head element is divided into a plurality of reproducing head element portions, the plurality of reproducing head element portions are arranged being made after a shape of the magnetization pattern recorded at the arbitrary position of the recording medium, and when the reproducing head element portions are connected to each other by electrodes, a shape of the gap formed between the reproducing head element and the magnetic recording surface is made to substantially agree with the shape of the magnetization pattern.

The fourth aspect of the present invention provides a magnetic head comprising the same recording head portion and reproducing head portion as those of the first aspect of the present invention, in which the reproducing head element is divided into a plurality of reproducing head element portions, the plurality of reproducing head element portions are arranged being made after a shape of the magnetization pattern recorded at the arbitrary position of the recording medium, the reproducing head element portions are connected to each other by electrodes and piezo electric elements, quality of a reproduction signal, which is obtained when the information is reproduced by the reproducing head element portions, is judged, and when a size of the piezo electric element corresponding to each reproducing head element portion is changed, a shape of the gap formed between the reproducing head element and the magnetic recording surface is made to substantially agree with the shape of the magnetization pattern.

The fifth embodiment of the present invention provides a disk apparatus comprising a disk drive unit for pivotally driving a disk; a magnetic head including a recording head portion for recording information at an arbitrary position on a magnetic recording surface of the disk and also including a reproducing head portion containing a reproducing head element for reproducing information recorded at the arbitrary position on the magnetic recording surface; a head drive unit for driving the magnetic head so that the magnetic head can be reciprocated between a position of an inner circumferential portion and a position of an outer circumferential portion of the disk; and a control unit for controlling various operations including an operation of recording information at the arbitrary position of the disk by using the magnetic head and also including an operation of reproducing information recorded at the arbitrary position of the disk, wherein when the reproducing head element is formed being made after a shape of the magnetization pattern recorded at the arbitrary position of the disk, a shape of the gap formed between the reproducing head element and the magnetic recording surface is made to substantially agree with the shape of the magnetization pattern.

As a summary of the present invention, according to the first aspect of the invention, the reproducing head element in the reproducing head portion is made after the curved shape of the magnetization pattern recorded on the magnetic recording surface of the recording medium. Due to the foregoing, a shape of the lead gap formed between the reproducing head and the magnetic recording surface can be made to substantially agree with the shape of the magnetization pattern. Accordingly, there is no possibility in which the reproducing head element reads a magnetization pattern, the shape of which is curved, in an end portion of the track. Therefore, edge noise generated at the end portion of the track is not reproduced. Accordingly, SN ratio of the reproduction signal is increased. In general, an allowable error range of the size of the reproducing head element in the reproducing head portion is larger than an allowable error range of the size of the primary magnetic pole portion in the recording head portion. Therefore, attention should be paid to an advantage in which the reproducing head element, the shape of which is curved as described above, can be relatively easily formed.

On the other hand, according to the second aspect of the present invention, a window portion (opening portion) is formed in a portion of the magnetic shielding member being made after the curved shape of the magnetization pattern recorded on the magnetic recording surface of the recording medium. When a reproducing head element, the size of which is not less than the size of the window portion, is combined with the magnetic shielding member, a shape of the lead gap corresponding to the window portion is made to substantially agree with the shape of the magnetization pattern. Therefore, in the same way as that of the first embodiment described before, there is no possibility in which the reproducing head element reads out a magnetization pattern that is curved at the end portion of the track. Accordingly, track edge noise generated at the end portion of the track is not reproduced and SN ratio of the reproduction signal is increased. In this case, it is not necessary to especially form a reproducing element, the shape of which is curved. Accordingly, it is possible to use the same rectangular reproducing head element as the conventional rectangular head reproducing element.

On the other hand, according to the third aspect of the present invention, the reproducing head element portions of small core width, which are divided into N pieces (In this case, N is an arbitrary positive integer not less than 2), are arranged being made after the curved shape of the magnetization pattern recorded on the magnetic recording surface of the recording medium and the reproducing head element portions are connected to each other by electrodes so that the entire reproducing head elements can be formed into a curved shape. Due to the foregoing, a shape of the lead gap is made to substantially agree with the shape of the magnetization pattern. Therefore, in the same way as that of the first and the second embodiment described before, there is no possibility in which the reproducing head element reads a magnetization pattern, the shape of which is curved, in an end portion of the track. Therefore, edge noise generated at the end portion of the track is not reproduced. Accordingly, SN ratio of the reproduction signal is increased. In this case, the reproducing head element portions of small core width are connected to each other and formed into an entirely curved reproducing head element. Therefore, it is relatively easy that a shape of the lead gap is made to agree with the shape of the above magnetization pattern.

On the other hand, according to the fourth aspect of the present invention, the reproducing head element portions of small core width, which are divided into N pieces, are arranged being made after the curved shape of the magnetization pattern recorded on the magnetic recording surface of the recording medium and the reproducing head element portions are connected to each other by electrodes and piezo electric elements. Further, quality of the reproduction signal generated by each reproducing head element portion is judged. According to the result of the judgment, a size of the corresponding piezo electric element is changed. Due to the foregoing, a shape of the lead gap, which is the most appropriate for the magnetization pattern, is realized. Due to the foregoing, the shape of the lead gap can be adjusted so that track edge noise generated at the end portion of the track can be minimized and SN ratio of the reproduction signal can be greatly enhanced.

On the other hand, according to the fifth aspect of the present invention, in the disk apparatus having the magnetic head (for example, the magnetic head of the first embodiment described before) of the present invention, when the reproducing head element is formed being made after the curved shape of the magnetization pattern recorded on the magnetic recording surface of the recording medium. Due to the foregoing, a shape of the lead gap is made to substantially agree with the shape of the magnetization pattern. Accordingly, there is no possibility in which a magnetization pattern curved at the edge portion of the track is read out. Therefore, edge noise generated at the track end portion is not reproduced and SN ratio of the reproducing noise is increased.

Accordingly, it is possible to increase the linear recording density (bit/inch, BPI) with respect to the longitudinal direction of the track on the disk in the disk apparatus. It is also possible to increase the track density (track/inch, TPI) with respect to the width direction of the track. Therefore, it is possible to provide an advantage in which the disk surface recording density is entirely increased.

### BRIEF DESCRIPTION OF THE DRAWINGS

Referring to the accompanying drawings, the present invention will be explained below, wherein:

FIG. 1 is a schematic illustration explaining a principle of recording information by a magnetic head of a common perpendicular magnetic recording system;

FIG. 2 is a sectional view showing an exemplary arrangement of a magnetic head of a conventional perpendicular magnetic recording system;

FIG. 3 is an enlarged sectional view showing a reproducing head portion of the magnetic head shown in FIG. 2;

FIG. 4 is an enlarged magnetization pattern view showing a magnetization pattern, which is recorded being curved and also showing an ideal magnetization pattern;

FIG. 5 is a plan view showing an outline of an arrangement of a mechanism portion of a disk apparatus including a magnetic head of the present invention;

FIG. 6 is a block diagram showing an arrangement of a control unit of a disk apparatus including a magnetic head of the present invention;

FIG. 7 is a schematic illustration showing an arrangement of a magnetic head of the first embodiment of the present invention;

FIG. 8 is a schematic illustration showing an arrangement of a magnetic head of the second embodiment of the present invention;

FIG. 9 is a schematic illustration showing an arrangement of a magnetic head of the third embodiment of the present invention;

FIG. 10 is a schematic illustration showing an arrangement of a magnetic head of the fourth embodiment of the present invention;

FIG. 11 is a block diagram showing an arrangement for controlling a piezo electric element in the fourth embodiment shown in FIG. 10;

FIG. 12 is a schematic illustration showing an arrangement of a magnetic head of the fifth embodiment of the present invention;

FIG. 13 is a schematic illustration showing an arrangement of a magnetic head of the sixth embodiment of the present invention; and

FIG. 14 is a schematic illustration showing an arrangement of a magnetic head of the seventh embodiment of the present invention.

### DESCRIPTION OF THE PREFERRED EMBODIMENTS

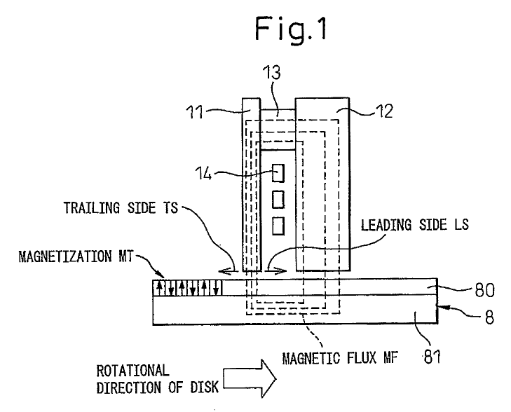

Before an arrangement of a disk apparatus including a magnetic head of the present invention and an arrangement of the magnetic head related to an embodiment of the present invention are explained, referring to the accompanying drawings (FIGS. 1 to 4), explanations will be made into a principle of recording information by a magnetic head of a common perpendicular magnetic recording system, a magnetic head of the conventional perpendicular magnetic recording system and problems caused by the magnetic head.

FIG. 1 is a schematic illustration explaining a principle of recording information by the magnetic head of the common perpendicular magnetic recording system. However, in this case, as a recording head portion of the magnetic head of the common perpendicular recording system, a single magnetic pole type perpendicular magnetic recording head is used. Referring to FIG. 1, the principle of recording information in the case of using the single magnetic pole type perpendicular magnetic recording head will be explained.

Generally, in the case in which information is recorded by the perpendicular magnetic recording head of the perpendicular magnetic recording system, the two perpendicular layer medium shown in FIG. 1 is used as a recording medium 8. This two perpendicular layer medium 8 includes a recording layer 80 that is a magnetic recording surface on which two types of magnetization MT magnetized in the perpendicular direction are recorded as information on the magnetic recording surface; and a backing layer 81 located in a lower portion of this recording layer, wherein the recording layer 80 and the backing layer 81 are laminated on each other. This backing layer 81 has a function of holding magnetization MT on the recording layer 8 in a direction perpendicular to the magnetic recording surface of the recording medium. Usually, this backing layer 81 is made of soft magnetic material such as Permalloy (FeNi) containing elements of iron (Fe) and nickel (Ni). Therefore, the backing layer 81 is referred to as a soft magnetic under layer (SUL). In the case in which the recording medium 8 is a disk, a downstream side in the rotational direction of the disk is a trailing edge side TS which is simply referred to as a trailing side. An upstream side is a leading edge side LS which is simply referred to as a leading side.

The perpendicular magnetic recording head shown in FIG. 1 includes a single primary magnetic pole portion 11 for impressing a magnetic field in the perpendicular direction upon a magnetic recording surface of the recording medium 8; an auxiliary magnetic pole portion 12 for absorbing a magnetic field coming outside through a recording layer 80 on the magnetic recording surface of the recording medium; and a connecting portion 13 made of magnetic material for magnetically connecting the primary magnetic portion 11 with the auxiliary magnetic pole portion 12. In the case in which information is recorded on the recording layer 80 of the recording medium 8, a predetermined magnetic field is generated by making an electric current flow in a thin film coil 14 arranged close to the primary magnetic pole portion 11. This magnetic field generated by the thin film coil 14 is made to pass through the primary magnetic pole portion 11 and impressed upon the recording layer 80 as a recording magnetic field in the perpendicular direction to the magnetic recording surface of the recording medium 8. Further, the magnetic field coming out from the recording layer 80 is absorbed by the auxiliary magnetic pole portion 12.

In other words, magnetic flux MF, which has been condensed in the primary magnetic pole portion 11 by the magnetic field made by the thin film coil 14, passes through the recording layer 80 and reaches the backing layer 81. Then, magnetic flux MF passes through the recording layer 80 again and enters the auxiliary magnetic pole portion 12. A magnetic circuit is formed by the primary magnetic pole portion 11, the recording medium 8, the auxiliary magnetic pole portion 12 and the connecting portion 13. By utilizing this magnetic circuit, magnetization MT (information), the direction of which is perpendicular to the magnetic recording surface of the recording medium 8, can be recorded on the recording layer 80. In the case in which information is recorded on the recording medium (two perpendicular layer medium), on which the recording layer and the backing layer are laminated on each other, by using the single magnetic pole type perpendicular magnetic head as described above, a correlation of the perpendicular magnetic head with the recording medium is considerably increased.

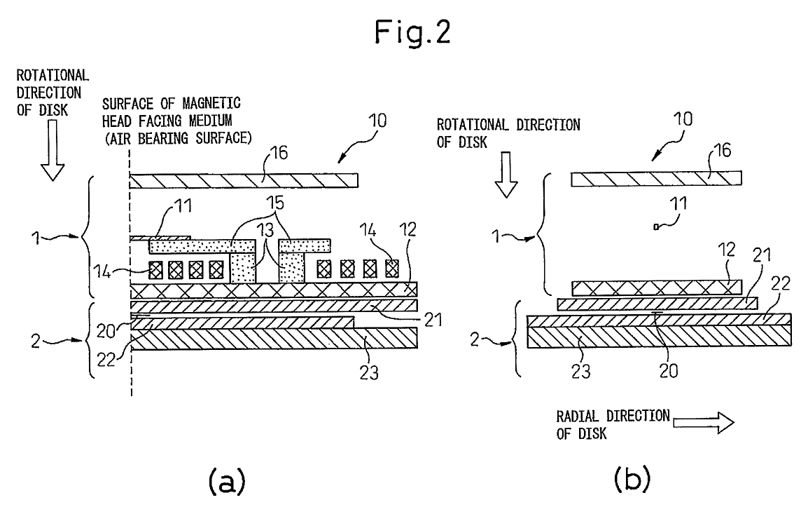

FIG. 2 is a sectional view showing an exemplary arrangement of the magnetic head of the conventional perpendicular magnetic recording system including the above single magnetic pole type perpendicular magnetic head. In this case, an outline of the arrangement of the magnetic head 10 is shown. The magnetic head 10 includes a recording head portion 1 formed out of the above single magnetic pole type perpendicular magnetic head; and a reproducing head portion 2 for reproducing information recorded at an arbitrary position on the recording layer of the recording medium (for example, two perpendicular layer medium). In this connection, portion (a) of FIG. 2 is a sectional view taken in the perpendicular direction to the surface of the magnetic head 10 facing the recording medium (i.e., air bearing surface (ABS) or head flying surface). Portion (b) of FIG. 2 is a sectional view taken along the surface of the magnetic head 10 facing the recording medium. In this connection, any components that are the same as those mentioned before will be indicated by using the same reference numerals, hereinafter.

In the magnetic head 10 shown in FIG. 2, in the substantially same way as that of the perpendicular magnetic recording head shown in FIG. 1, the perpendicular magnetic recording head 1 includes a single primary magnetic pole 11 for impressing a magnetic field in the perpendicular direction upon the magnetic recording surface of the recording medium; an auxiliary magnetic pole portion 12 for absorbing a magnetic field coming outside through the recording layer (shown in FIG. 1) on the magnetic recording surface of the recording medium; and a connecting portion 13 made of magnetic material for magnetically connecting the primary magnetic portion 11 with the auxiliary magnetic pole portion 12. Further, in the recording head portion 1 shown in FIG. 2, in order to concentrate the magnetic field made by the thin film coil 14 on the primary magnetic pole portion 11 and effectively supply the magnetic field to the primary magnetic pole portion 11, a yoke portion 15 made of magnetic material is provided between the primary magnetic pole portion 11 and the connecting portion 13. Further, in the recording head portion 1 shown in FIG. 2, in order to prevent a stray magnetic filed, which comes from the outside of the magnetic head 10, from entering the recording head portion, a recording head portion shielding layer 16 made of magnetic material is arranged in an upper portion of the magnetic head 10. Generally, the primary magnetic pole portion 11, the auxiliary magnetic pole portion 12, the connecting portion 13, the thin film coil 14, the yoke portion 15 and the recording head shielding layer 16, which are components arranged in the recording head portion 1, are covered with a non-magnetic insulating layer. However, this non-magnetic insulating layer is omitted in the description of FIG. 2.

In the magnetic head 10 shown in FIG. 2, in the case of recording information on the recording layer of the recording medium, in the substantially same way as that of the perpendicular magnetic recording head shown in FIG. 1, an electric current is made to flow in the thin film coil 14 arranged close to the primary magnetic pole portion 11 and a predetermined magnetic field is generated. The magnetic field generated by the thin film coil 14 passes through the yoke portion 15 and is impressed upon the recording layer being formed into a recording magnetic field perpendicular to the magnetic recording surface of the recording medium. Further, the magnetic field, which comes out from the recording layer, is absorbed by the auxiliary magnetic pole portion 12. The above yoke portion 15, the primary magnetic pole portion 11, the recording medium, the auxiliary magnetic pole portion 12 and the connecting portion 13 compose a magnetic circuit. By utilizing this magnetic circuit, a piece of magnetization information, which is perpendicular to the magnetic recording surface of the recording medium, can be recorded on the recording layer.

In the magnetic head 10 shown in FIG. 2, the reproducing head portion 2 includes a lower shielding layer 22 made of magnetic material, formed on the non-magnetic board 23 made of ceramic material such as Altic (Al₂O₃.TiO); a reproducing head element 20, which is a magnetic resistance effect element (MR element), formed on the lower shielding layer 22 through a non-magnetic insulating layer not shown; and an upper shielding layer 21 made of magnetic material, formed on the reproducing head element 20 through a non-magnetic insulating layer not shown. The upper shielding layer 21 and the lower shielding layer 22 have a function of preventing a stray magnetic field from entering the reproducing head element from the outside and the thickness of each layer is, for example, 1 to 2 μm. The reproducing head element is an element, which is formed out of a magnetism sensitive film exhibiting a magneto-resistance effect, such as AMR (anisotropic magneto-resistance effect) element, GMR (giant magneto-resistance effect) element or TMR (tunneling magneto-resistance effect) element.

Further, on the upper shielding layer 20 of the reproducing head portion 2, a non-magnetic insulating layer (not shown) is formed. On this non-magnetic insulating layer, the auxiliary magnetic pole portion 12 of the recording head portion 1 is formed. The thin film coil 14, the connecting portion 13, the yoke portion 15, the primary magnetic pole portion 11 and the recording head portion shielding layer 16 are formed in an upper portion of this auxiliary magnetic pole portion 12.

In the disk apparatus such as a magnetic disk apparatus, when the recording head portion 1 (the single magnetic pole type perpendicular magnetic recording head) shown in FIG. 2 is used, information is recorded at an arbitrary position on the magnetic recording surface of the recording medium. Alternatively, when the reproducing head portion 2 shown in FIG. 2 is used, information recorded at the arbitrary position on the magnetic recording surface can be reproduced.

In this case, in the magnetic recording apparatus such as a magnetic disk apparatus, in order to increase a recording capacity per unit area of the recording medium such as a disk, it is necessary to increase a surface recording density of the recording medium. In order to increase the surface recording density of the recording medium, it is necessary to increase a linear recording density with respect to the longitudinal direction of the track of the recording medium such as a disk, i.e., a linear recording density with respect to the rotational direction of the recording medium such as a disk. It is also necessary to increase a track density with respect to the longitudinal direction of the track, i.e., a track density with respect to the radial direction of the recording medium such as a disk.

Generally, the recording medium such as a disk includes tracks which are formed into a plurality of concentric circles to which the magnetic head can have access. Further, each track is divided into a plurality of recording regions. Each of the plurality of recording regions is formed out of a plurality of bits and referred to as “sectors”. It is typical that the length of 1 bit of the track of the recording medium used at present is 50 to 70 μm and the track width is 200 nm.

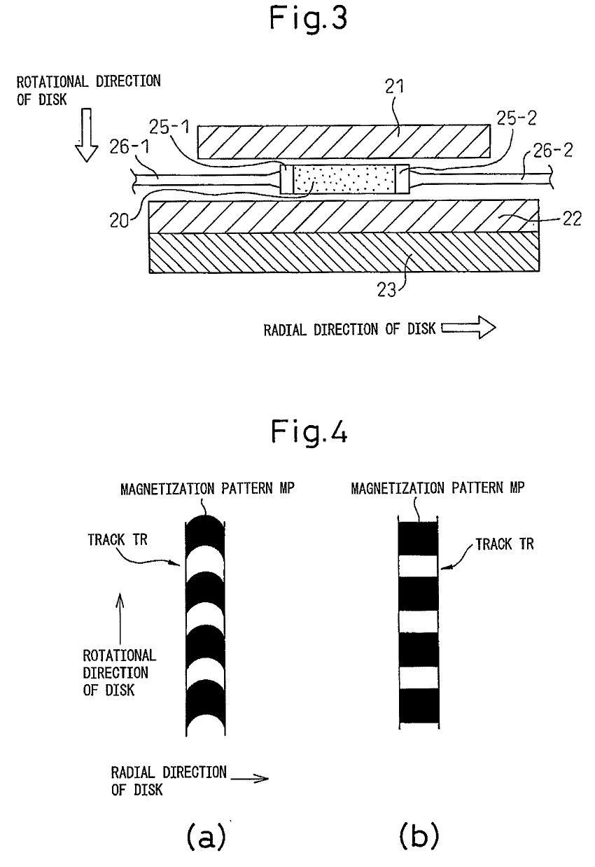

FIG. 3 is an enlarged sectional view showing a reproducing head portion of the magnetic head shown in FIG. 2. In the sectional view of FIG. 3, a primary portion of the reproducing head portion 1 shown in FIG. 2 is shown being enlarged, wherein this sectional view is drawn along the surface of the magnetic head facing the recording medium.

As explained before in FIG. 2, the reproducing head portion 1 includes a lower shielding layer 22 made of magnetic material formed on the non-magnetic board 23; a reproducing head element 20 such as MR element, formed on the lower shielding layer 22 through a non-magnetic insulating layer; and an upper shielding layer 21 made of magnetic material, formed on the reproducing head element 20 through a non-magnetic insulating layer.

To both end portions of the reproducing head element 20, a pair of electrodes 25-1, 25-2 made of non-magnetic conductive material are connected. To the pair of electrodes 25-1, 25-2, lead terminal portions 26-1, 26-2 made of non-magnetic conductive material are respectively connected. When a predetermined electric current is supplied from the lead terminal portions 26-1, 26-2 and the pair of electrodes 25-1, 25-2 to the reproducing head element 20, it becomes possible to read out and reproduce information, which is recorded on the magnetic recording surface of the recording medium, by using the reproducing head element 20 such as MR element.

As shown in FIG. 3, in the case of the magnetic head of the conventional perpendicular magnetic recording system, a shape of the head flying surface of the reproducing head element 20 is rectangular. In this case, a shape of the lead gap formed between the reproducing head portion 2 (shown in FIG. 2) and the magnetic recording surface of the recording medium becomes rectangular because it is determined by the shape of the reproducing element 20.

FIG. 4 is a magnetization pattern view in which a magnetization pattern, which is recorded being curved, and an ideal magnetization pattern are shown being enlarged.

In the case in which information is recorded by the perpendicular magnetic recording system in the recording medium, in which the recording layer and the backing layer are laminated on each other, by using the magnetic head of the conventional perpendicular magnetic recording system, a distribution of the recording magnetic field intensity, which is impressed upon the recording surface of the recording medium by the primary pole portion 11 (shown in FIG. 2) of the recording head portion 1 (show in FIG. 2), is greatly different from that of the case of recording information by the longitudinal magnetic recording system. Specifically, contour lines of the recording magnetic field intensity in the case of recording information by the perpendicular magnetic recording system are distributed as concentric circles, the center of which agrees with the center of the primary magnetic pole portion 11 in which the intensity of the magnetic field is the maximum. In this distribution of the contour lines, the outside is swelled. Therefore, the distribution of the recording magnetic field intensity on the trailing side, which decides a state of magnetization on the magnetic recording surface of the recording medium, is curved.

In the case in which information is written in the recording medium such as a disk by using the recording head portion 1 having the recording magnetic field distribution described above, a state of the magnetization pattern in the case of observing the magnetization pattern by utilizing an image obtained through MFM (magnetic force microscopy) is shown in FIG. 4 being enlarged. Portion (a) of FIG. 4 shows magnetization pattern MP which is recorded by the magnetic head of the conventional perpendicular magnetic recording system being curved. Portion (b) of FIG. 4 is a view showing an ideal magnetization pattern MP. In FIG. 4, a direction of magnetization of magnetization pattern MP in the perpendicular direction to the magnetic recording surface is inverted by the bit unit. This state is shown by black-and-white contrast.

As shown in portion (a) of FIG. 4, concerning the radial direction of the disk, a position at which a magnetizing direction of magnetization pattern MP is inverted at the center of track TR on the disk is located on the rotary side of the disk compared with a position at which a magnetizing direction of magnetization pattern MP is inverted at the end portion of track TR. Therefore, an inversion shape in the case in which the direction of magnetization of magnetization pattern MP on the disk is inverted is curved. On the other hand, an inversion shape of the magnetization pattern in the case in which information is written in an ideal state is a linear shape (a rectangular shape) having an excellent white-and-black contrast as shown in portion (b) of FIG. 4.

In the case in which information is reproduced with respect to the magnetization pattern, the shape of which is curved as shown in portion (a) of FIG. 4, by the reproducing head portion, the shape of the lead gap of which is rectangular, a portion of the bit in the front is reproduced by an end portion of track TR with respect to the radial direction of the disk. Therefore, in the magnetic head of the conventional perpendicular magnetic recording system, track edge noise generated at the end portion of track TR is mixed in the reproduction signal and a ratio of signal to noise (SN ratio) of the reproducing medium is lowered. At the same time, according to an increase in the linear recording density of the recording medium, a track width, in which the curved magnetization pattern is recorded, is substantially reduced.

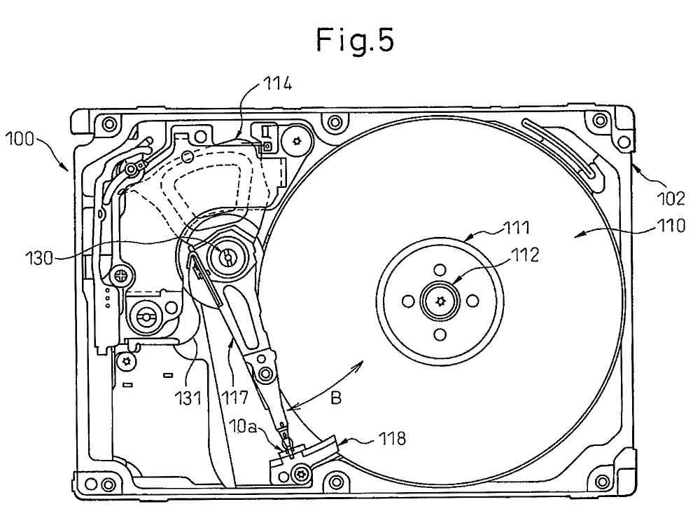

Referring now to the accompanying drawings (FIGS. 5 to 14), detailed explanations will be made into an arrangement of the disk apparatus including a magnetic head of the present invention and an arrangement of the magnetic head of an embodiment of the present invention.

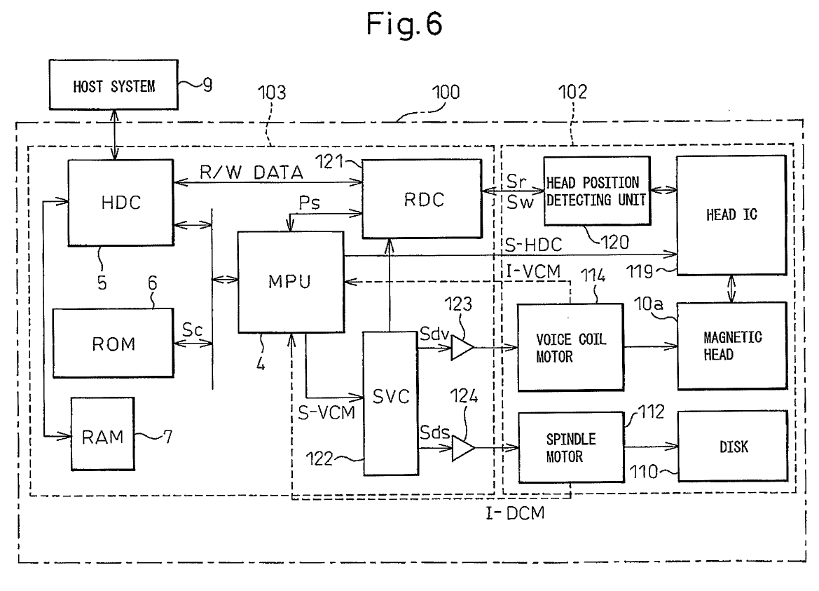

FIG. 5 is a plan view showing an outline of the arrangement of a mechanism portion of a disk apparatus including a magnetic head of the present invention. FIG. 6 is a block diagram showing an arrangement of a control unit of the disk apparatus.

However, in this case, the disk apparatus of the embodiment of the present invention is a disk apparatus 100 such as a magnetic disk apparatus having a magnetic head 10a of the present invention for recording and reproducing information (data) on a rotating disk 110 such as a hard disk.

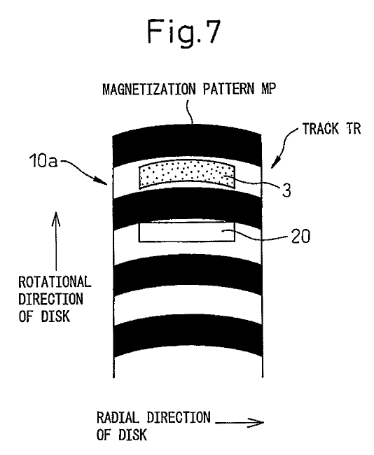

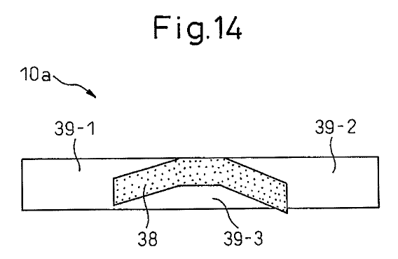

In this case, the magnetic head 10a is composed of a magnetic head of the embodiment of the present invention described later referring to FIG. 14. This magnetic head 10a includes a recording head portion (for example, the recording head portion 1 of the conventional magnetic head shown in FIG. 1 described before) for recording information at an arbitrary position (track) on the recording surface of the disk 110; and a reproducing head portion having a reproducing head element (for example, the reproducing head element shown in FIGS. 7 to 14) for reproducing information recorded at an arbitrary position on the magnetic recording surface described before.

For example, when the disk apparatus 100 shown in FIGS. 5 and 6 has a magnetic head of the perpendicular magnetic recording system of the first embodiment of the present invention shown in FIG. 7 described later, in the reproducing head portion of the magnetic head concerned, and when a reproducing head element is formed being made after a curved shape of the magnetization pattern recorded in the track on the magnetic recording surface of the disk 110, a shape of the lead gap is made to substantially agree with the shape of the above magnetization pattern. Due to the foregoing, there is no possibility in which the reproducing head element reads out a magnetization pattern, the shape of which is curved, in an end portion of the track. Accordingly, edge noise generated at the end portion of the track is not reproduced and SN ratio of the reproduction signal is increased.

To put it briefly, the disk apparatus 100 shown in FIGS. 5 and 6 includes a mechanism portion 102 formed out of a disk 110, magnetic head 10a, spindle motor 112 and voice coil motor 114 arranged in the disk apparatus; and a control unit 103 for controlling various operations such as a data writing operation and a data reading operation made by the magnetic head 10a. In this case, various components composing the mechanism portion 102 are accommodated in a disk enclosure. An electronic circuit composing the control unit 103 is formed out of an integrated circuit such as a plurality of LSI (large scale integrated circuit) mounted on an assembly (assembly board) of a printed circuit. The above mechanism portion 102 includes a disk 110 on which a single hard disk or a plurality of hard disks are rotated by a spindle motor 112 connected to a spindle 111.

The above spindle 111 and spindle motor 112 compose a primary portion of the disk drive unit for pivotally driving the disk 110. An operation of the spindle motor 112 is controlled by a servo controller 122 as shown in FIG. 6, the abbreviation of which is SVC, of the control unit 103.

On the magnetic recording surface on the front face (or the back face) of the disk 110, a plurality of tracks (or a plurality of cylinders) are formed. At an arbitrary position of the track, which is also referred to as a sector, a data pattern corresponding to predetermined data is written in.

In this case, the terminology “cylinder” indicates an aggregation of a plurality of tracks, i.e., the terminology “cylinder” indicates a plurality of tracks, the shape of which is formed into a cylindrical shape, in which a plurality of disks are laminated on each other in the vertical direction so that a plurality of magnetic heads can simultaneously have access to the disks.

Specifically, in a disk apparatus in which a servo surface type servo system is used, a magnetic recording surface of one of the plurality of disks is formed into a servo surface on which a servo signal pattern corresponding to a servo signal for servo control is formed. All magnetic recording surfaces of other disks are data surfaces on which data patterns are formed. On the other hand, in the disk apparatus in which the data surface servo system is used, both data patterns and servo signal patterns are formed on the magnetic recording surfaces of a plurality of disks. Recently, there is a tendency in which the disk apparatus using the latter data surface type servo system is commonly used.

As described before, in the disk apparatus 100 shown in FIG. 5, the magnetic head 10a is provided which is used for writing in data at an arbitrary position on the magnetic recording surface of the disk 110 and at the same time reading out data written in at an arbitrary position on the magnetic recording disk. This magnetic head 10a is mounted on a forward end portion of the arm 117 for holding the head. This arm 117 is driven being reciprocated between the position in the inner circumferential portion (on the inner side) of the disk 110 and the position in the outer circumferential portion (on the outer side) by the voice coil motor 114 controlled by the servo controller 122 (shown in FIG. 6). Due to the foregoing, access can be made to all the data regions, in which data is written, on the magnetic recording surface of the disk. In this case, in order to smoothly reciprocate the arm 117, a pivot bearing 130 is attached to the center of the voice coil motor 114. The arm 117, the voice coil motor 114 and the pivot bearing 130 compose a primary portion of the head drive unit for driving the magnetic head 10a.

For example, when the arm 117 is rotated in the direction of arrow B by the voice coil motor 114, the magnetic head 10a is moved in the radial direction of the disk 110, so that a predetermined track can be scanned. A component including the voice coil motor 114 and the arm 117 is referred to as a head actuator. This head actuator is attached with a flexible printed board, the abbreviation of which is FPC (flexible printed circuit) 131. Servo signal Sdv (shown in FIG. 6) for controlling an operation of the voice coil motor 114 and the magnetic head 10a is supplied through the flexible printed board 131.

A ramp mechanism 118 is arranged in the outer circumferential portion of the disk 110. The ramp mechanism 118 is engaged with a forward end portion of the arm 117 so that the magnetic head 10a can be held being separate from the disk 110.

Further, the disk apparatus 100 includes an interface connector (not shown) for connecting the control unit 103 (shown in FIG. 6) of the disk apparatus 100 with the host system 9 (shown in FIG. 6) such as a host processor arranged outside.

Referring to FIG. 6, an arrangement of the control unit of the disk apparatus of the embodiment of the present invention will be explained in detail.

As shown in FIG. 6, a reproduction signal, which has been read out from the disk 110 by the magnetic head 10a, is supplied to head IC 119 provided in the disk enclosure. After the reproduction signal has been detected and amplified by the head position detecting portion 120, it is sent to the control unit 103.

In the control unit 103 shown in FIG. 6, the read channel 121, the abbreviation of which is RDC in FIG. 3, for demodulating data information and servo information Ps from reproduction signal Sr supplied by head IC 119, and the micro-processor unit, the abbreviation of which is MPU in FIG. 6, for controlling all operations related to reading/writing of data according to servo information outputted from the read channel 121, are mounted on the printed circuit assembly. It is possible to take out positional information, which is related to a track position on the disk surface of the magnetic head 10a, from servo information Ps described above.

Further, in the control unit shown in FIG. 6, the hard disk controller 5, the abbreviation of which is HDC in FIG. 3, for controlling an operation of the disk apparatus 100 according to a command given from the host system 9 such as a host processor arranged outside the disk apparatus 100, ROM (Read-Only Memory) 6 for storing a program to carry out reading/writing of data, RAM (Random Access Memory) 7 for temporarily storing data to be read out and written in and the servo controller 122 for controlling operations of the spindle motor 112 and the voice coil motor 114 are mounted on the printed circuit assembly. It is preferable that dynamic RAM, the abbreviation of which is usually DRAM, of high speed and large capacity is used for RAM 7.

In the control unit composed as described above, in the case in which a writing command for writing data is given from the host system 9, MPU 4 operates according to the program (program related information Sc) which is previously stored in ROM 6 and sends out a read channel control signal to the read channel 121. This read channel 121 sends out writing signal Sw to head IC 119 according to the data signal (R/W DATA) used for reading/writing. This head IC 119 amplifies writing signal Sw and sends it out to the magnetic head 10a.

On the other hand, in the case in which a read command for reading data is given from the host system 9, MPU 4 operates according to the program (program related information Sc) previously stored in ROM 6 and sends out hard disk control signal S-HDC to head IC 119. This head IC 119 amplifies a reproduction signal outputted from the magnetic head 10a and sends it out to the read channel 121. According to the data signal (R/W DATA) for writing/reading, the read channel 121 confirms whether or not reproduction signal Sr is read out from a sector located at a proper position on the disk surface and sends out servo information Ps including the positional information, which is related to the sector position, to MPU 4.

Further, MPU 4 generates VCM control signal S-VCM for controlling an operation of the voice coil motor 114 according to various control signals, which are sent from the host system 9, and servo information Ps and sends out the signals to the servo controller 122. Servo signal Sdv for the voice coil motor generated together with this VCM control signal S-VCM is supplied to the voice coil motor 114 through the driver 123. According to this servo signal Sdv, the voice coil motor 114 is started, that is, electric current I-VCM flows in the voice coil motor 114 and the magnetic head 10a is acted so as to seek a designated position. At the same time, servo signal Sds for the spindle motor generated according to VCM control signal C-VCM is supplied to the spindle motor 112 through the driver 124. According to this servo signal Sds, the spindle motor 112 is started, i.e., electric current I-DCM flows in the spindle motor 112 and the disk 110 is rotated.

The constitution of the control unit described above is basically the same as that of the control unit of the commonly used disk apparatus.

In the disk apparatus related to the embodiment shown in FIGS. 5 and 6, in the case in which the control unit shown in FIG. 6 is operated by using a recording medium capable of being read with a computer, it is preferable to prepare a recording medium (for example, the disk 110 such as a hard disk provided in the disk apparatus 100) which holds a content of the above program. In this connection, the recording medium is not limited to the above specific recording medium. Examples of the recording medium are various portable recording mediums such as a floppy disk, MO (magneto-optical disk), CD-R (compact disk-recordable) and CD-ROM (compact disk read-only memory). Examples of the recording medium are also various stationary recording medium.

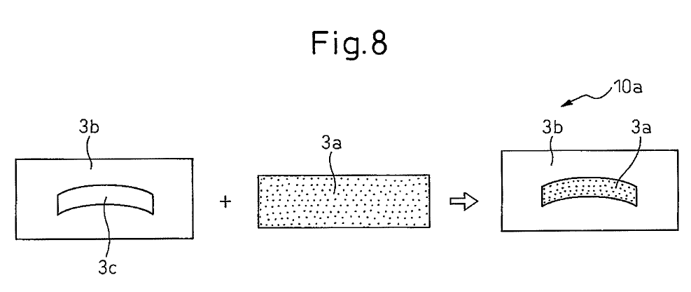

According to the disk apparatus related to the embodiment shown in FIGS. 5 and 6, when the reproducing head element composed as shown in FIG. 7 described later or the reproducing head element composed as shown in one of FIGS. 8 to 14 is used, a shape of the lead gap can be made to substantially agree with the shape of the magnetization pattern on the magnetic recording surface of the disk. Accordingly, there is no possibility in which the reproducing head element reads a curved magnetization pattern at an end portion of the track. Therefore, SN ratio of the reproduction signal is increased.

Accordingly, the linear recording density with respect to the longitudinal direction of the track on the disk in the disk apparatus is increased and the track density with respect to the lateral direction of the track is also increased. As a result, the surface recording density can be entirely increased.

FIG. 7 is a schematic illustration showing an arrangement of the magnetic head of the first embodiment of the present invention. However, in this case, an arrangement of the reproducing head element 3, which is a characteristic portion of the magnetic head 10a of the perpendicular magnetic recording system of the first embodiment of the present invention, is shown being simplified here.

As explained before referring to FIG. 4, concerning the radial direction of the disk, a position at which the direction of magnetization of magnetization pattern MP is inverted at the center of track TR on the disk is located on the rotational direction side of the disk as compared with a position at which the direction of magnetization of magnetized pattern MP is inverted at the end portion of track TR. Therefore, an inverted shape is curved in the case in which the direction of magnetization of magnetization pattern MP on the disk is inverted. Magnetization pattern MP of the curved shape is shown again in FIG. 7.

When information of magnetization pattern MP, which is curved as shown in FIG. 7, is reproduced by the reproducing head element 20 of the conventional magnetic head, the shape of the lead gap of which is rectangular, a portion of the bit in the front is reproduced by the end portion of track TR with respect to the radial direction of the disk. Therefore, in the case of the reproducing head element 20 of the conventional magnetic head, track edge noise of the end portion of track TR is mixed in the reproduction signal and SN ratio of the reproduction signal is lowered.

On the other hand, in the case of the magnetic head 10a of the first embodiment shown in FIG. 7, when the reproducing head element 3, which is curved being made after the curved shape of magnetization pattern MP, is formed, a shape of the lead gap between the reproducing head element 3 and the magnetic recording surface is made to substantially agree with the shape of magnetization pattern MP.

Therefore, in the case of the magnetic head 10a of the first embodiment shown in FIG. 7, there is no possibility in which the reproducing head element 3 reads out the curved magnetization pattern at the end portion of track TR. As a result, track edge noise generated at the end portion of track TR is not reproduced and SN ratio of the reproduction signal is increased.

Generally, an allowable error range of the size of the reproducing element 3 is larger than an allowable error range of the size of the primary magnetic pole portion (for example, shown in FIG. 2) provided in the recording head portion. Accordingly, from a technical viewpoint, it is easy to make the curved reproducing head element 3 shown in FIG. 7.

FIG. 8 is a schematic illustration showing an arrangement of the magnetic head of the second embodiment of the present invention. However, in this case, arrangements of the reproducing head element 3a and the magnetic shielding member 3b, which are characteristic portions of the magnetic head 10a of the perpendicular magnetic recording system of the second embodiment of the present invention, are shown being simplified here.

In the magnetic head 10a of the second embodiment shown in FIG. 8, portions of the upper shielding layer (shown in FIG. 3) and the lower shielding layer (shown in FIG. 3) of the reproducing head portion are formed out of the magnetic shielding member 3b and the curved window portion 3c is formed in a portion of the magnetic shielding member 3b being made after the curved shape of magnetization pattern MP (shown in FIG. 7). Further, the reproducing head element 3a, the size of which is not less than the size of the window portion 3c of the magnetic shielding member 3b, is formed. This reproducing head element 3a and the magnetic shielding element 3b are stuck to each other so that they can be combined with each other. According to this structure, a magnetic flux generated by magnetization pattern MP (shown in FIG. 7) can be only read out in the window portion 3c of the reproducing head element 3a. As a result, a shape of the lead gap formed between the reproducing head element 3a and the magnetic recording surface can be made to substantially agree with the shape of magnetization pattern MP (shown in FIG. 7). In this connection, in the case shown in FIG. 8, the reproducing head element 3a is formed into a rectangular shape. However, as long as the size of the reproducing head element 3a is not less than the size of the window portion 3c of the magnetic shielding member 3b, it is possible to use a reproducing head element formed into any shape.

According to the magnetic head 10a of the second embodiment of the present invention shown in FIG. 8, in the same way as that of the first embodiment (shown in FIG. 7), the reproducing head element 3a does not read out the curved magnetization pattern in the edge portion of the track. Accordingly, track edge noise generated in the edge portion of the track is not reproduced. Accordingly, SN ratio of the reproduction signal is increased. In this case, it is not necessary to especially form a curved reproducing head element and it is possible to use the same rectangular reproducing head element as that of the conventional case.

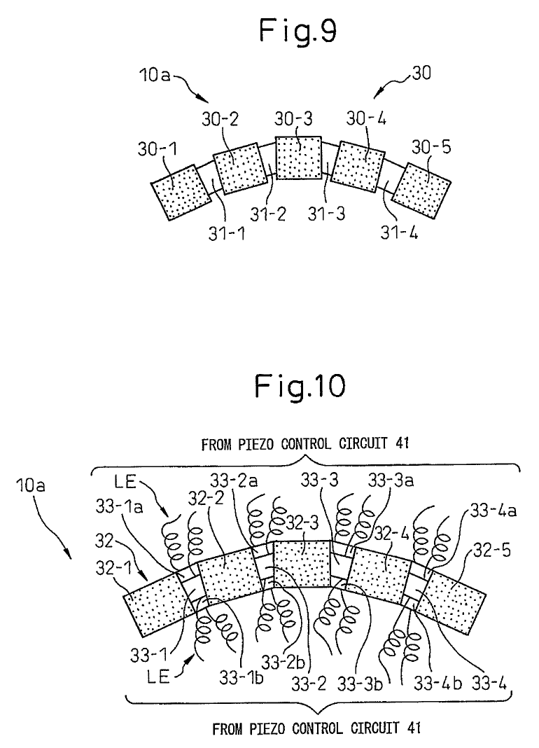

FIG. 9 is a schematic illustration showing an arrangement of the magnetic head of the third embodiment of the present invention. However, in this case, an arrangement of the reproducing head element 30, which is a characteristic portion of the magnetic head 10a of the perpendicular magnetic recording system of the third embodiment of the present invention, is shown being simplified here.

In the magnetic head 10a of the third embodiment shown in FIG. 9, the reproducing head element 30 is divided into the reproducing head element portions, the number of which is N, wherein N is an arbitrary positive integer not less than 2. The entire reproducing head element portions, the number of which is N, are arranged into a curved shape being made after the curved shape of magnetization pattern MP. For example, in the case shown in FIG. 9, the reproducing head element 30 is divided into 5 reproducing head element portions 30-1, 30-2, 30-3, 30-4 and 30-5. However, it should be noted that the present invention is not limited to the above specific embodiment. Further, when the adjacent reproducing head element portions are connected to each other by a plurality of electrodes 31-1, 31-2, 31-3 and 31-4, a shape of the lead gap formed between the reproducing head element 30 and the magnetic recording surface can be made to substantially agree with the shape of magnetization pattern MP (shown in FIG. 7).

According to the magnetic head 10a of the third embodiment shown in FIG. 9, in the same way as that of the embodiment (shown in FIGS. 7 and 8) described before, the reproducing head element 30 formed out of a plurality of reproducing head element portions does not read out magnetization pattern MP (shown in FIG. 7), the shape of which is curved, in the end portion of the track. Accordingly, track edge noise generated in the end portion of the track is not reproduced and SN ratio of the reproduction signal is increased.

In the third embodiment described above, when the reproducing head element portions of small core width are connected to each other, the curved reproducing head element 30 is entirely formed. Therefore, it is relatively easy to make the shape of the lead gap agree with the shape of the magnetization pattern.

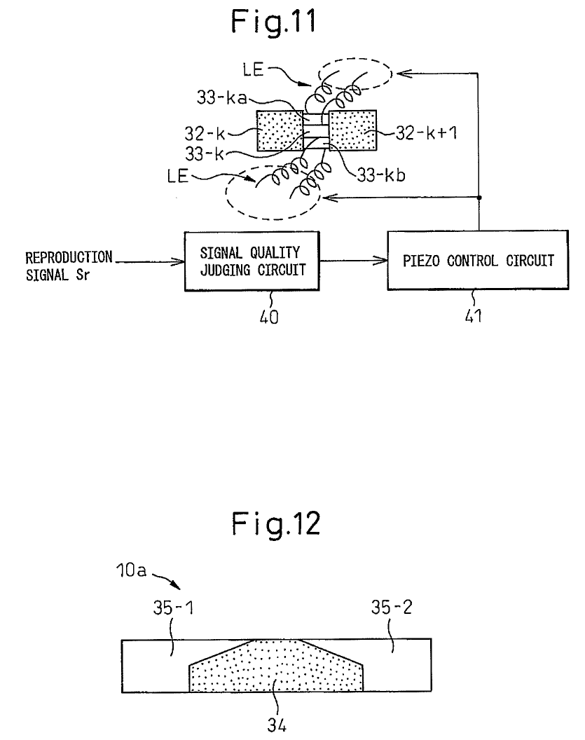

FIG. 10 is a schematic illustration showing an arrangement of the magnetic head of the fourth embodiment of the present invention. FIG. 11 is a block diagram showing an arrangement for controlling a piezo electric element in the embodiment shown in FIG. 10. However, in this case, an arrangement of the reproducing head element 30, which is a characteristic portion of the magnetic head 10a of the perpendicular magnetic recording system of the fourth embodiment of the present invention, is shown being simplified here. Further, an arrangement of the electronic circuit for controlling the reproducing head element 30 is shown being simplified here. In the magnetic head 10a of the fourth embodiment shown in FIG. 10, in the same way as that of the embodiment shown in FIG. 9, the reproducing head element 32 is divided into the reproducing head element portions, the number of which is N. The entire reproducing head element portions, the number of which is N, are arranged into a curved shape being made after the curved shape of magnetization pattern MP (shown in FIG. 7). For example, in the case shown in FIG. 10, the reproducing head element 30 is divided into 5 reproducing head element portions 32-1, 32-2, 32-3, 32-4 and 32-5. However, it should be noted that the present invention is not limited to the above specific embodiment. Further, the adjacent reproducing head elements are connected to each other by a plurality of electrodes 33-1, 33-2, 33-3 and 33-4 being made after the curved shape of magnetization pattern MP (shown in FIG. 7) and the adjacent reproducing head element portions are connected to each other by a plurality of piezo electric elements 33-1a, 33-1b, 33-2a, 33-2b, 33-3a, 33-3b, 33-4a and 33-4b.

As shown in FIG. 11, the fourth embodiment of the present invention includes a signal quality judging circuit 40 for judging quality of reproduction signal Sr obtained when information of the magnetization pattern (shown in FIG. 7) is reproduced by each reproducing head element portion; and a piezo electric control circuit 41 for controlling a piezo electric element corresponding to each reproducing head element portion in accordance with voltage outputted as a result of the judgment of quality of reproduction signal Sr made by this signal quality judging circuit 40. This piezo electric control circuit 41 is connected to the piezo electric element corresponding to each reproducing head element portion through lead terminal portion LE.

For example, as shown in FIG. 11, the reproducing head element portions 32-k, 32-k+1, which are adjacent to each other, (In this case, k is an arbitrary positive integer of 1≦k≦(N−1)), are connected to each other by the piezo electric elements 33-ka, 33-kb. Further, these piezo electric elements 33-ka, 33-kb are connected to the piezo electric control circuit 41 through lead terminal portions LE.

Further, in the fourth embodiment shown in FIGS. 10 and 11, quality of reproduction signal Sr, which is obtained when information of the magnetization pattern (shown in FIG. 7) is reproduced by each reproducing head element portion, is judged. According to voltage outputted as a result of the quality judgment of this reproduction signal Sr, a size of the piezo electric element corresponding to each reproducing head element portion is changed. Due to the foregoing, a shape of the lead gap formed between the reproducing head element 32 and the magnetic recording surface is made to substantially agree with the shape of magnetization pattern MP (shown in FIG. 7).

It is preferable that the electronic circuit including the signal quality judging circuit 40 and the piezo electric control circuit 41 shown in FIG. 11 is mounted on the same printed board as that of the electronic circuit composing the control unit of the disk apparatus shown in FIG. 6. Further, the electronic circuit including the signal quality judging circuit 40 and the piezo electric control circuit 41 shown in FIG. 11 is formed out of an integrated circuit in the same way as that of the control unit of the disk apparatus shown in FIG. 6 described before.

According to the fourth embodiment shown in FIGS. 10 and 11, the reproducing head element portions of small core width, which are divided into N pieces, are arranged and each reproducing head element portion is connected to the electrode and the piezo electric element. Further, quality of the reproduction signal made by each reproducing head element portion is judged. According to the result of the judgment, a size of the corresponding piezo electric element is changed. Due to the foregoing, the most appropriate lead gap for the magnetization pattern is realized. Accordingly, the shape of the lead gap can be adjusted so that track edge noise generated in the track edge portion can be minimized. Therefore, SN ratio of the reproduction signal can be greatly enhanced as compared with the case of the embodiment described before (shown in FIGS. 7 to 9).

FIG. 12 is a schematic illustration showing an arrangement of the magnetic head of the fifth embodiment of the present invention. However, in this case, the constitution of the reproducing head element 34 and a pair of electrodes 35-1, 35-2, which are characteristic portions of the magnetic head 10a of the perpendicular magnetic recording system of the fifth embodiment of the present invention, is shown being simplified.

In the magnetic head 10a of the fifth embodiment shown in FIG. 12, while consideration is being given to the curved shape of magnetization pattern MP (shown in FIG. 7), a portion of each of the electrodes 35-1, 35-2, which are arranged at both end portions of the reproducing head element 34, is extended and thus extended electrode portion is formed into a substantially triangular shape at two corner portions of the reproducing head element 34. Further, the electrodes 35-1, 35-2, the shapes of which are composed as described above, are connected to the reproducing head element 34. Generally, the electrodes 35-1, 35-2 are made of non-magnetic conductive material. Therefore, a magnetic flux generated by magnetization pattern MP (shown in FIG. 7) is read out by the reproducing head element 34, the shape of which is substantially curved as shown in FIG. 12. As a result, a shape of the lead gap formed between the reproducing head element 34 and the magnetic recording surface can be made to substantially agree with the shape of magnetization pattern MP (shown in FIG. 7).

According to the magnetic head 10a of the fifth embodiment shown in FIG. 12, in the same way as that of the embodiment described before (shown in FIGS. 7 to 11), there is no possibility in which the reproducing head element 34 reads out a magnetization pattern curved at an end portion of the track. Therefore, track edge noise generated at the track end portion is not reproduced. Accordingly, SN ratio of the reproduction signal is increased.

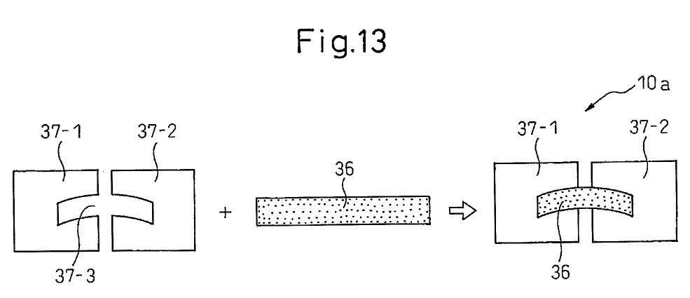

FIG. 13 is a schematic illustration showing an arrangement of the magnetic head of the sixth embodiment of the present invention. This drawing shows a simplified arrangement of the reproducing head element 36 and the electrodes 37-1, 37-2 which are characteristic portions of the magnetic head 10a of the perpendicular magnetic head recording system of the sixth embodiment of the present invention.

In the magnetic head 10a of the sixth embodiment shown in FIG. 13, the window portion 37-3 is formed in portions of the electrode members (37-1, 37-2) made of non-magnetic conductor material being made after the shape of the magnetization pattern MP (shown in FIG. 7). This window portion 37-3 divides the electrode members (37-1, 37-2) into two at the substantial central portion. The electrode members (37-1, 37-2) are combined with each other when the reproducing head element 36, the size of which is not less than that of the window portion (37-3) of the electrode member (37-1, 37-2), and the two divided electrode members (37-1, 37-2) are stuck to each other. According to this structure, a magnetic flux generated by magnetization pattern MP (shown in FIG. 7) can be read in only by the window portion 37-3 of the reproducing head element 34. As a result, a shape of the lead gap formed between the reproducing head element 36 and the magnetic recording surface can be made to substantially agree with the shape of magnetization pattern MP (shown in FIG. 7). In this connection, as shown in FIG. 13, the reproducing head element 36 is rectangular. However, as long as the size of the reproducing head element 34 is not less than that of the window portion 37-3 of the electrode member (37-1, 37-2), it is possible to use a reproducing head element of any shape.

According to the magnetic head 10a of the sixth embodiment shown in FIG. 13, in the same way as that of the embodiment (shown in FIGS. 7 to 12) described before, there is no possibility in which the reproducing head element 36 reads a magnetization pattern, the shape of which is curved at an end portion of the track. Therefore, no edge noise generated at an end portion of the track is reproduced. Accordingly, SN ratio of the reproduction signal is increased. In this case, it is not necessary to especially form a curved reproducing head element. Therefore, it is possible to use the same rectangular reproducing head element as the conventional ones.

FIG. 14 is a schematic illustration showing an arrangement of the magnetic head of the seventh embodiment of the present invention. This drawing shows a simplified arrangement of the reproducing head element 38, the first electrodes 39-1, 39-2 and the second electrode 39-3 which are characteristic portions of the magnetic head 10a of the perpendicular magnetic head recording system of the seventh embodiment of the present invention.

In the magnetic head 10a of the seventh embodiment shown in FIG. 14, when consideration is given to the curved shape of magnetization pattern MP (shown in FIG. 7), portions of the first electrodes 39-1, 39-2, which are located at both end portions of the reproducing head element 38, are extended and these extended portions of the electrodes are formed into a substantially triangular shape at the corner portion on one side of the reproducing head element 38. In a portion on the other side of the reproducing head element 38, the second electrode 39-3, the shape of which is formed into a substantial trapezoid, is formed. Further, the reproducing head element 38 is connected to the first electrodes 39-1, 39-2 and the second electrode 39-3. Furthermore, one of the first electrodes 39-1, 39-2 is connected to the second electrode 39-3. In the case shown in FIG. 14, the first electrode 39-1 on the left side and the second electrode 39-3 are connected to each other. Generally, the first electrodes and the second electrode 39-1, 39-2 and 39-3 are made of non-magnetic conductive material. Accordingly, a magnetic flux generated by magnetization pattern MP (shown in FIG. 7) is read out by the reproducing head element 38, the shape of which is curved as shown in FIG. 14. As a result, a shape of the lead gap formed between the reproducing head element 38 and the magnetic recording surface can be made to substantially agree with the shape of magnetization pattern MP (shown in FIG. 7).

According to the magnetic head 10a of the seventh embodiment shown in FIG. 14, in the same way as that of the embodiment (shown in FIGS. 7 to 13) described before, there is no possibility in which the reproducing head element 38 reads a magnetization pattern, the shape of which is curved at an end portion of the track. Therefore, no edge noise generated at an end portion of the track is reproduced. Accordingly, SN ratio of the reproduction signal is increased. In this case, a shape of the reproducing head element 38 is similar to the shape of magnetization pattern MP (shown in FIG. 7) as compared with the shape in the case of the embodiment shown in FIG. 13 described before. Therefore, SN ratio can be enhanced as compared with the case of the embodiment shown in FIG. 13 before. In this case, it becomes unnecessary to especially form a curved reproducing head element. Therefore, it is possible to use the same rectangular reproducing head element as the conventional ones.

When the reproducing head element, the structure of which is shown in FIGS. 7 to 14, is applied to a disk apparatus, there is no possibility in which the reproducing head element provided in the magnetic head of the disk apparatus reads a magnetization pattern, the shape of which is curved in an end portion of the track. Accordingly, SN ratio of the reproduction signal is increased. Accordingly, the linear recording density with respect to the longitudinal direction of the track on the disk in the disk apparatus is increased and the track density with respect to the lateral direction of the track is also increased. As a result, the surface recording density can be entirely increased.

The present invention can cope with circumstances in which the density of the recording medium such as a disk is highly increased. Therefore, the present invention can be applied to a magnetic disk apparatus or an optical magnetic disk apparatus provided with a magnetic head having a reproducing head element which reproduces information recorded on a magnetic recording surface of a recording medium by especially using the perpendicular magnetic recording system.

1. A magnetic head comprising a recording head portion for recording information at an arbitrary position on a magnetic recording surface of a recording medium; and a reproducing head portion including a reproducing head element for reproducing information recorded at the arbitrary position on the magnetic recording surface, wherein:
when the reproducing head element is formed being made after a shape of a magnetization pattern recorded at the arbitrary position of the recording medium, a shape of a gap formed between the reproducing head element and the magnetic recording surface is made to be substantially the same as the shape of the magnetization pattern.

2. The magnetic head according to claim 1, wherein a window portion is formed in one portion of a magnetic shielding member being made after the shape of the magnetization pattern recorded at the arbitrary position of the recording medium, and when a reproducing head element, the size of which is not less than the size of the window portion of the magnetic shielding member, and the magnetic shielding member are combined with each other, a shape of the gap formed between the reproducing head element and the magnetic recording surface is made to be substantially the same as the shape of the magnetization pattern.

3. The magnetic head according to claim 1, wherein the reproducing head element is divided into a plurality of reproducing head element portions, the plurality of reproducing head element portions are arranged being made after a shape of the magnetization pattern recorded at the arbitrary position of the recording medium, and when the reproducing head element portions are connected to each other by electrodes, a shape of the gap formed between the reproducing head element and the magnetic recording surface is made to substantially agree with the shape of the magnetization pattern.

4. The magnetic head according to claim 1, wherein the reproducing head element is divided into a plurality of reproducing head element portions, the plurality of reproducing head element portions are arranged being made after a shape of the magnetization pattern recorded at the arbitrary position of the recording medium, and the reproducing head element portions are connected to each other by electrodes and piezo electric elements, and wherein:
quality of a reproduction signal, which is obtained when the information is reproduced by the reproducing head element portions, is judged, and when a size of the piezo electric element corresponding to each reproducing head element portion is changed, a shape of the gap formed between the reproducing head element and the magnetic recording surface is made to substantially agree with the shape of the magnetization pattern.

5. The magnetic head according to claim 1, wherein when the electrode is formed so that portions of the electrodes arranged at both end portions of the reproducing head can be formed into a substantially triangular shape at the corner portion of the reproducing head being made after the shape of the magnetization pattern recorded at the arbitrary position of the recording medium and when the reproducing head element is connected to the electrode, a shape of the gap formed between the reproducing head element and the magnetic recording surface is made to substantially agree with the shape of the magnetization pattern.

6. The magnetic head according to claim 1, wherein when a window portion is formed in a portion of the electrode member being made after the shape of the magnetization pattern recorded at the arbitrary position of the recording medium and when the electrode member is divided into two portions at a substantially central portion of the electrode member and when the reproducing head element, the size of which is not less than that of the window portion of the electrode member, and the electrode member, which is divided into two portions, are combined with each other, a shape of the gap formed between the reproducing head element and the magnetic recording surface is made to substantially agree with the shape of the magnetization pattern.

7. The magnetic head according to claim 1, wherein when first electrodes are formed so that portions of the first electrodes arranged at both end portions of the reproducing head can be formed into a substantially triangular shape in a corner portion on one side of the reproducing head element being made after the shape of the magnetization pattern recorded at the arbitrary position of the recording medium and when a second electrode, the shape of which is a substantially trapezoidal shape, is formed in a portion on the other side of the reproducing head element and when the reproducing head element is connected to the first electrodes and the second electrode, a shape of the gap formed between the reproducing head element and the magnetic recording surface is made to substantially agree with the shape of the magnetization pattern.

8. A disk apparatus comprising:
a disk drive unit for pivotally driving a disk;
a magnetic head including a recording head portion for recording information at an arbitrary position on a magnetic recording surface of the disk and also including a reproducing head portion containing a reproducing head element for reproducing information recorded at the arbitrary position on the magnetic recording surface;
a head drive unit for driving the magnetic head so that the magnetic head can be reciprocated between a position of an inner circumferential portion and a position of an outer circumferential portion of the disk; and
a control unit for controlling various operations including an operation of recording information at the arbitrary position of the disk by using the magnetic head and also including an operation of reproducing information recorded at the arbitrary position of the disk, wherein:
when the reproducing head element is formed being made after a shape of the magnetization pattern recorded at the arbitrary position of the disk, a shape of the gap formed between the reproducing head element and the magnetic recording surface is made to substantially agree with the shape of the magnetization pattern.
